(19) United States
(12) Patent Application Publication
(10) Pub. No.: US 2026/0341257 A1
(43) Pub. Date: Oct. 29, 2026

(54) PULSE HEATING METHOD OF POWER BATTERY, PULSE CURRENT GENERATION DEVICE, PULSE HEATING SYSTEM OF POWER BATTERY AND VEHICLE

(71) Applicant: HONDA MOTOR CO., LTD., Tokyo (JP)

(72) Inventors: Guanting DU, Guangzhou (CN); Chuyun GUO, Guangzhou (CN); Shoshi HIDAKA, Guangzhou (CN)

(21) Appl. No.: 19/653,584

(22) Filed: Apr. 21, 2026

(30) Foreign Application Priority Data
Apr. 24, 2025 (CN) 202510526243.7

(51) Int. Cl. G10H 5/04; H05B 1/02; H05B 3/00

(52) U.S. Cl. CPC G10H 5/04; H05B 1/0236; H05B 3/0019; G10H 2240/005; G10H 2250/471; G10H 2250/615

(57) ABSTRACT

A pulse heating method of a power battery includes: a step of acquiring a target audio parameter; a step of generating a target current signal base on the target audio parameter; a step of calculating a pulse width modulation signal for adjusting a current, at least based on the target current signal; a step of adjusting a pulse current using the pulse width modulation signal, and outputting the adjusted pulse current; and a step of heating the power battery using the adjusted pulse current.

### BACKGROUND OF THE INVENTION

### Field of the Invention

The present invention relates to the field of vehicles and power batteries, and in particular, to a pulse heating method of a power battery, a pulse current generation device, a pulse heating system of a power battery and a vehicle.

### Description of Related Art

With the advancement of science and technology and the growing need for environmental protection, new energy vehicles are developing rapidly and are increasingly occupying an important position in the automotive market.

The power battery is an important component of new energy vehicles, and the performance of the power battery has an important impact on the overall performance of new energy vehicles. In cold regions or low-temperature environments, the performance of the power battery of new energy vehicles decreases significantly, resulting in limited vehicle power and range decrease. In order to improve the performance and adaptability of new energy vehicles in low-temperature environments, pulse heating technology has emerged as an effective battery heating technology. During the pulse heating process, the heating system generates a large pulse current, which causes the pulse heating system to resonate and emit noise, affecting users of vehicles.

In recent years, several technologies have emerged that aim to reduce or improve the noise generated by resonance in the pulse heating system.

For example, a target tune of the music is determined according to a pulse heating current request value. A switching frequency of an insulated gate bipolar transistor (IGBT) is determined according to the target tune. A period corresponding to each switching frequency is determined according to the takt time of the music. In each period, a corresponding switching frequency and a preset duty cycle are input to the IGBT, and the IGBT outputs current. By controlling the IGBT to adjust the duty cycle, a current value of the IGBT gradually approaches the pulse heating current request value, thereby changing a frequency of a resonance sound of the heating system, converting the resonance sound into a specific tone and melody.

For another example, audio output information is acquired in a battery heating mode. An audio parameter is determined based on the audio output information, and the audio parameter is a frequency domain signal including at least pitch and volume. A heating command is determined based on the audio parameter, and a frequency of a pulse current is adjusted using the heating command, thereby changing the frequency of the resonance sound of the heating system, converting the resonance sound into a specific tone and melody.

It should be noted that the above description of the technical background is provided solely to facilitate a clear and complete description of the technical solutions of the present invention and to aid in the understanding of those skilled in the art. The above technical solutions cannot be considered to be known to those skilled in the art merely because these solutions are described in the description of related art of the present invention.

### SUMMARY OF THE INVENTION

The inventors found that in the above related art, it is necessary to determine the switching frequency according to the target tune and to determine the period determined by each switching frequency according to the takt time. In each period, the pulse current frequency is adjusted by adjusting the switching frequency, and the current amplitude is adjusted by adjusting the duty cycle. This results in a complex control process and slow response speed, and it takes a considerable amount of time to demonstrate the efficiency of converting the resonance sound into a specific tone and melody, resulting in a poor user experience. In the above related art, the frequency of the pulse current needs to be adjusted, which affects the magnitude of the output pulse current and thus the heating effect on the power battery. In addition, in the above related art, the resonance sound caused by the pulse current is a triangular wave rather than a sine wave, resulting in a less pleasant sound quality.

In order to solve one or more problems or similar problems in the above related art, embodiments of the present invention provide a pulse heating method for a power battery, a pulse current generation device, a pulse heating system for a power battery, and a vehicle. Through a simple control process, a pulse current used for heating a power battery is adjusted using a PWM signal generated based on a target audio parameter, and a resonance sound caused by the pulse current can be quickly and effectively converted into pleasant music or melody, thereby improving the user experience and comfort.

According to a first aspect of the embodiments of the present invention, a pulse heating method of a power battery includes: a step of acquiring a target audio parameter; a step of generating a target current signal at least based on the target audio parameter; a step of calculating a pulse width modulation (PWM) signal for adjusting a current, at least based on the target current signal; a step of adjusting a pulse current using the pulse width modulation (PWM) signal, and outputting the adjusted pulse current; and a step of heating the power battery using the adjusted pulse current.

Optionally, the step of acquiring a target audio parameter includes a step of acquiring predetermined or user-selected melody or music, and a step of generating, based on the melody or music, a corresponding time-domain audio signal as the target audio parameter or a part of the target audio parameter. In this way, the music or melody as the target for resonance sound conversion may be predetermined or selected by a user, which improves the user convenience and flexibility. In addition, the time-domain audio signal generated based on the melody or music is used as the target audio parameter or a part thereof, so as to generate a time-domain controlled PWM signal. Therefore, the music or melody can be reproduced directly based on time-domain control, and the response speed is fast.

Optionally, the method further includes: a step of updating the melody or music based on an operation command of a user; and a step of generating a corresponding time-domain audio signal based on the updated melody or music, and updating the target audio parameter or a part of the target audio parameter. In this way, the user can edit the melody or music according to his/her preference, and the resonance sound caused by the pulse current can be converted into the music or melody favored by the user, thereby further improving the user experience and comfort.

Optionally, the target current signal is a sine wave signal or an approximate sine wave signal. In this way, the pulse width modulation (PWM) signal generated based on the target current signal can also be formed as a smooth sine wave or an approximate sine wave, thereby better generating pleasant music or melody.

Optionally, the step of generating the target current signal at least based on the target audio parameter includes a step of generating the target current signal based on the target audio parameter, a sound resonance transfer function, and an audio gain function. The sound resonance transfer function is determined according to a relation and structure between a pulse current generation device configured to output the pulse current, and a vehicle, and the audio gain function is adjusted based on a user preference and is set based on a gain of each frequency band. In this way, by combining the target audio parameter, the sound resonance transfer function based on a vehicle structure, and the audio gain function based on a user preference, a target current signal is generated that better matches actual conditions of the vehicle and preferences of the user. This allows the PWM signal generated based on the target current signal to be more accurate, resulting in more effective adjustment of the pulse current.

Optionally, the target audio parameter includes a time-domain audio signal, and the target current signal is equal to a product of the time-domain audio signal, the sound resonance transfer function, and the audio gain function. In this way, the target current signal can be quickly and accurately determined.

Optionally, a modulation frequency of the pulse width modulation (PWM) signal is greater than a preset threshold, which is an upper limit of a sound frequency perceivable by a human ear. In this way, the pulse current is adjusted using a high-frequency PWM signal, which is above the range of human hearing, and the high-frequency modulation produces smaller current ripples. This can reduce the noise generated by the pulse current within a sound frequency range perceivable by a human ear, making the resonance sound closer to the frequency curve of the music or melody.

Optionally, the pulse width modulation (PWM) signal is a pulse width modulation (PWM) signal or a pulse width modulation (PWM) signal sequence at a specific time. In this way, the pulse current can be adjusted using a PWM signal with a short occupation time, achieving a fast response and thus quickly converting the resonance sound into music or melody.

Optionally, the step of adjusting the pulse current using the pulse width modulation (PWM) signal, and outputting the adjusted pulse current includes a step of inputting the pulse width modulation (PWM) signal into a switching element, and a step of adjusting an amplitude of a pulse current output by the switching element using the pulse width modulation (PWM) signal, thereby obtaining the adjusted pulse current. In this way, the amplitude of the pulse current is adjusted in the time domain only based on the PWM signal, without the need to control or change the switching frequency of the switching element. This achieves a fast response without affecting the pulse current, that is, the heating effect on the power battery is ensured while the noise conversion effect is achieved.

Optionally, the step of calculating the pulse width modulation (PWM) signal for adjusting a current, at least based on the target current signal includes a step of calculating the pulse width modulation (PWM) signal based on the target current signal and frequency characteristics of other noises in a vehicle. In this way, the PWM signal can be further generated in combination with other noises in the vehicle. Thus, the music or melody converted from the resonance sound can cover other noises in the vehicle, thereby further improving the user experience and comfort.

According to a second aspect of the embodiments of the present invention, a pulse current generation device, includes: a calculation unit configured to calculate a pulse width modulation (PWM) signal at least based on a target current signal; and an output unit configured to adjust a pulse current using the pulse width modulation (PWM) signal, and output the adjusted pulse current, and wherein the target current signal is generated based on a target audio parameter.

According to a third aspect of the embodiments of the present invention, the pulse heating system of a power battery includes: an acquisition unit configured to acquire a target audio parameter; a vehicle control unit configured to generate a target current signal based on the target audio parameter; the pulse current generation device according to the second aspect of the embodiments of the present invention, configured to receive at least the target current signal and output the pulse current adjusted with a pulse width modulation (PWM) signal; and a heating unit configured to heat the power battery using the adjusted pulse current.

According to a fourth aspect of the embodiments of the present invention, a vehicle includes: the pulse current generation device according to the second aspect of the embodiments of the present invention, or the pulse heating system of a power battery according to the third aspect of the embodiments of the present invention.

One of the advantageous effects of the embodiments of the present invention is as follows.

The target current signal is generated based on the target audio parameter, the PWM signal is generated based on the target current signal, the pulse current is directly adjusted using the PWM signal in the time domain, and the power battery is heated using the adjusted pulse current. Thus, through a simple control process, the resonance sound caused by the pulse current can be quickly and effectively converted into pleasant music or melody, thereby improving the user experience and comfort.

Since the pulse current is adjusted using PWM only in the time domain and not controlled or adjusted in the frequency domain, it does not affect the pulse current, and therefore does not affect the heating effect on the power battery.

In addition, the resonance sound caused by the pulse current in this manner can be converted into music or melody with a sine wave or similar waveform, which has a good auditory effect, can make the user feel pleasant, and improve the user experience.

Embodiments of the present invention will be disclosed in detail with reference to the following description and accompanying drawings. It should be understood that the embodiments of the present invention are not limited in scope. Within the scope and terms of the appended claims, the embodiments of the present invention include many variations, modifications, and equivalents.

The features that are described and/or illustrated with respect to one embodiment may be used in one or more other embodiments in the same or similar manner, combined with features in other embodiments, or substituted for features in other embodiments.

It should be emphasized that the term “including/comprising/having” when used herein refers to the presence of a feature, assembly, or component, but does not exclude the presence or addition of one or more other features, assemblies, or components.

### BRIEF DESCRIPTION OF THE DRAWINGS

The above and other objects, features and advantages of the embodiments of the present invention will become more apparent from the following detailed description taken in conjunction with the accompanying drawings.

FIG. 1 is a block diagram of a pulse heating method of a power battery according to an embodiment of the present invention.

FIG. 2 is a block diagram of a method for acquiring a target music parameter according to the embodiment of the present invention.

FIG. 3 is a block diagram of a method for adjusting a pulse current using a pulse width modulation (PWM) signal according to the embodiment of the present invention.

FIG. 4 is a waveform diagram of a pulse width modulation (PWM) signal applied to an IGBT according to the embodiment of the present invention.

FIG. 5 is a waveform diagram illustrating the generation of a pulse width modulation (PWM) signal using a target current signal according to the embodiment of the present invention.

FIG. 6 is a flowchart of an embodiment of the pulse heating method of a power battery according to an embodiment of the present invention.

FIG. 7 is a block diagram of a pulse current generation device according to an embodiment of the present invention.

FIG. 8 is a block diagram of a pulse heating system of a power battery according to an embodiment of the present invention.

### DETAILED DESCRIPTION OF THE INVENTION

The above and other features of the present invention will become apparent from the following specification with reference to the accompanying drawings. The specification and drawings disclose specific embodiments of the present invention, which illustrate some embodiments in which the principles of the present invention may be employed. It should be understood that the present invention is not limited to the embodiments described, but includes all modifications and equivalents falling within the scope of the appended claims.

The pulse heating method of a power battery, the pulse heating device, the pulse heating system of a power battery, and the vehicle according to the embodiments of the present invention will be described in detail below with reference to the accompanying drawings.

### Embodiment of First Aspect

An embodiment of the present invention provides a pulse heating method of a power battery.

The power battery in the embodiment of the present invention may be various types of power batteries, for example, the power battery may be a lithium battery, a nickel-metal hydride battery, a sodium-sulfur battery, or a lead-acid battery.

The power battery in the embodiment of the present invention is installed in a vehicle, and is used to provide power or partial power for the vehicle.

The vehicle according to the embodiment of the present invention may be a vehicle of various applications, such as a small passenger car, a truck, etc.

The vehicle according to the embodiment of the present invention may be various types of vehicles that use power batteries, such as new energy vehicles, hybrid electric vehicles, etc.

The pulse heating method for a power battery according to an embodiment of the present invention may be performed by one or more devices or equipment. For example, some steps are performed by a cloud device, and some steps are performed by a local device, or all steps may be performed by a local device.

For example, the local device includes, but is not limited to, a vehicle controller, an in-vehicle terminal, a pulse current generation device, and a mobile terminal used by a user, and the cloud device includes, but is not limited to, a cloud server.

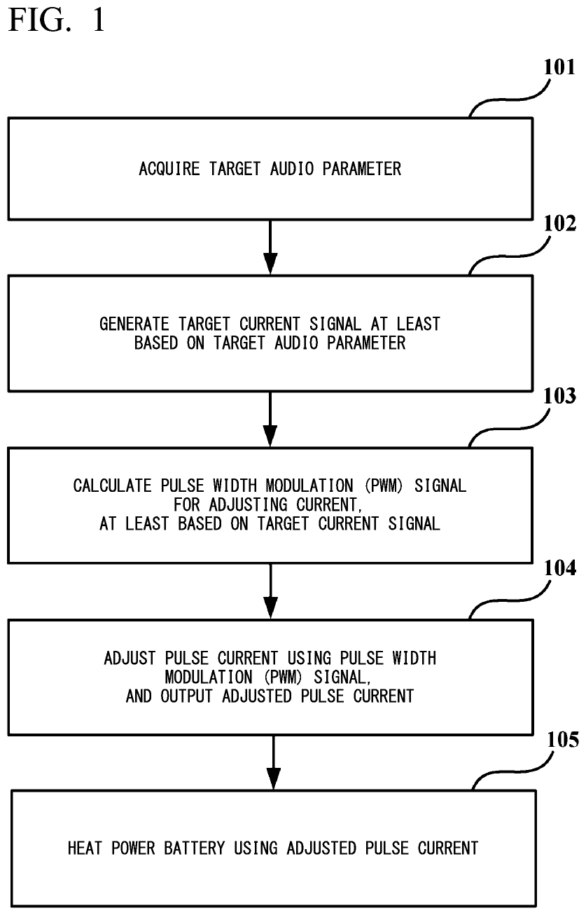

FIG. 1 is a block diagram of the pulse heating method of a power battery according to the embodiment of the present invention. As illustrated in FIG. 1, the method includes:
a step 101 of acquiring a target audio parameter;
a step 102 of generating a target current signal at least according to the target audio parameter;
a step 103 of calculating a pulse width modulation (PWM) signal for adjusting a current, at least based on the target current signal;
a step 104 of adjusting a pulse current using the pulse width modulation (PWM) signal, and outputting the adjusted pulse current; and
a step 105 of heating the power battery using the adjusted pulse current.

In this way, the target current signal is generated based on the target audio parameter, the PWM signal is generated based on the target current signal, the pulse current is directly adjusted using the PWM signal in the time domain, and the power battery is heated using the adjusted pulse current. Thus, through a simple control process, a resonance sound caused by the pulse current can be quickly and effectively converted into pleasant music or melody, thereby improving the user experience and comfort.

Since the pulse current is adjusted using PWM only in the time domain and not controlled or adjusted in the frequency domain, it does not affect the pulse current, and therefore does not affect the heating effect on the power battery.

In addition, the resonance sound caused by the pulse current in this manner can be converted into music or melody with a sine wave or similar waveform, which has a good auditory effect, can make the user feel pleasant, and improve the user experience.

The steps of the method will be described in detail below. The following description is for the purpose of better understanding the present invention, rather than limiting the present invention.

In step 101, a target music parameter is acquired.

In some embodiments, the target music parameter refers to a music parameter of music or melody that is desired to be converted from a resonance sound generated when the power battery is heated using a pulse current.

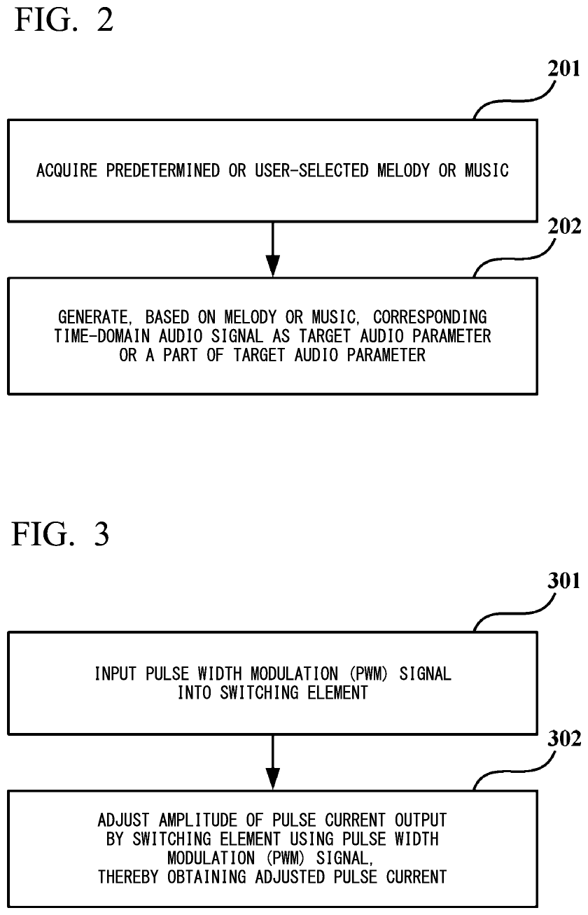

FIG. 2 is a block diagram of a method of acquiring a target music parameter according to the embodiment of the present invention. As illustrated in FIG. 2, the method includes:
a step 201 of acquiring predetermined or user-selected melody or music; and
a step 202 of generating, based on the melody or music, a corresponding time-domain audio signal as the target audio parameter or a part of the target audio parameter.

In this way, the music or melody as the target for resonance sound conversion may be predetermined or selected by a user, which improves the user convenience and flexibility. In addition, the time-domain audio signal generated based on the melody or music is used as the target audio parameter or a part thereof, so as to generate a time-domain controlled PWM signal. Therefore, the music or melody can be reproduced directly based on time-domain control, and the response speed is fast.

In step 201, the acquired melody or music may be predetermined or selected by a user.

For example, melody or music for resonance sound conversion when the battery is heated is pre-stored in a memory of an in-vehicle infotainment. When the user activates or the system automatically activates a power battery pulse heating function, the relevant melody or music is directly retrieved from the memory.

For another example, a plurality of pieces of melody or music used for resonance sound conversion when the battery is heated are pre-stored in the memory of the in-vehicle infotainment. When the user activates or the system automatically activates the power battery pulse heating function, a plurality of pieces of melody or music available for selection by the user are displayed on a screen of an in-vehicle terminal or a mobile terminal of the user. After the user makes a selection, the melody or music selected by the user is retrieved from the memory.

For another example, a plurality of pieces of melody or music for resonance sound conversion when the battery is heated are pre-stored on a cloud server. When the user activates or the system automatically activates the power battery pulse heating function, a plurality of pieces of melody or music available for selection by the user are displayed on a screen of an in-vehicle terminal or a mobile terminal of the user. After the user makes a selection, the command based on the selection of the user is sent to the cloud server, and the melody or music selected by the user is retrieved from the server.

For another example, when the user activates or the system automatically activates the power battery pulse heating function, an interface for the user to set and search for melody or music is displayed on a screen of an in-vehicle terminal or a mobile terminal of the user. The user can search for his/her favorite melody or music in the cloud and set the melody or music as the melody or music used for resonance sound conversion when the battery is heated.

In some embodiments, the acquired melody or music may be a complete piece of music or a part of music, and the embodiments of the present invention do not limit the duration of the acquired melody or music. During the process of heating the power battery with pulse, this melody or music may be reproduced repeatedly.

In step 202, a corresponding time-domain audio signal is generated as the target audio parameter or a part of the target audio parameter, according to the melody or music.

In some embodiments, the target audio parameter includes a time-domain audio signal.

For example, a corresponding time-domain audio signal Sₒᵤₜ is generated through analysis according to predetermined or user-selected melody or music.

In some embodiments, the time-domain audio signal is, for example, pitch at a certain time or a specific time.

For example, the time-domain audio signal Sₒᵤₜ is an instantaneous value obtained by differentiating an audio signal of the music or melody. Specifically, it is obtained by sampling a continuous signal at fixed time intervals, that is, converting a continuous signal into a discrete-time signal.

In addition, in some embodiments, an audio deviation ΔS may also be obtained.

For example, the audio deviation ΔS is a difference between the target current signal and the actual output (instantaneous value of pulse current), that is, audio deviation=target current signal−actual output signal.

In some embodiments, the melody or music may also be updated based on an operation command of the user. A corresponding time-domain audio signal is generated based on the updated melody or music, and the target audio parameter or a part of the target audio parameter is updated.

In this way, the user can edit the melody or music according to his/her preference, and the resonance sound caused by the pulse current can be converted into the music or melody favored by the user, thereby further improving the user experience and comfort.

In some embodiments, editing the melody or music refers to adjusting a music parameter of the melody or music. For example, the music parameter includes at least one of pitch, timbre, tone, volume, musical style, reverberation, delay, gain, musical phase, frequency-dependent sound pressure, power amplifier channel, and rhythm of the music.

For example, the user edits the selected melody or music using an equalizer (EQ), such as adjusting the music parameter through the EQ, and generating a corresponding time-domain audio signal based on the adjusted music.

For another example, the user edits the selected melody or music using a voice command. For example, if the user says “I want something more cheerful,” then the music parameter of the melody or music selected by the user is adjusted based on this voice command, making the adjusted music sound more cheerful. For example, the musical style or rhythm of the music is adjusted, and a corresponding time-domain audio signal is generated based on the adjusted music.

In some embodiments, after hearing the melody or music converted from the resonance sound during the process of heating the battery with the pulse current, the user can re-select the melody or music based on their perception, or edit the selected melody or music. The user can also regenerate the target current signal and the PWM signal based on the re-selected or edited melody or music, and adjust the pulse current based on the regenerated PWM signal. Thus, the melody or music converted from the resonance sound in the process of heating the battery with the pulse current continuously approaches the preference of the user.

After the target music parameter is acquired, in step 102, a target current signal is generated at least according to the target audio parameter.

In some embodiments, the target current signal is a sine wave signal or an approximate sine wave signal. In this way, the pulse width modulation (PWM) signal generated based on the target current signal can also be formed as a smooth sine wave or an approximate sine wave, thereby better generating pleasant music or melody.

In some embodiments, the target current signal is generated according to the target audio parameter, a sound resonance transfer function, and an audio gain function. The sound resonance transfer function is determined according to a relation and structure between a pulse current generation device configured to output the pulse current, and a vehicle, and the audio gain function is adjusted based on a user preference and set based on a gain of each frequency band. For example, the relation and structure between the pulse current generation device and the vehicle include a location where the pulse current generation device is installed in the vehicle, a connection relation with the vehicle, and a connection structure.

In this way, by combining the target audio parameter, the sound resonance transfer function based on a vehicle structure, and the audio gain function based on a user preference, a target current signal is generated that better matches actual conditions of the vehicle and preferences of the user. This allows the PWM signal generated based on the target current signal to be more accurate, resulting in more effective adjustment of the pulse current.

For example, a resonance transfer function G1(s) is acquired according to the relation and structure between the pulse current generation device and the vehicle. A gain function G2(s) is acquired, which is adjusted according to a preference of the user and set based on the gain of each frequency band. The vehicle control unit employs negative feedback control to calculate, based on the audio signal Sₒᵤₜ and the audio deviation ΔS at the current moment, a current signal I required to generate melody that matches the auditory perception of the user, that is, the target current signal, using G1(s) and G2(s).

In some embodiments, the target current signal is equal to a product of the time-domain audio signal, the sound resonance transfer function, and the audio gain function, that is, target current signal=Sₒᵤₜ×G1(s)×G2(s). In this way, the target current signal can be quickly and accurately determined.

In addition, for the resonance transfer function G1(s) and the gain function G2(s), reference may be made to the related art, which will not be specifically described herein.

After the target current signal is generated, in step 103, a PWM signal for adjusting a current is calculated at least based on the target current signal.

For example, the vehicle control unit sends the current signal I, that is, the target current signal, to the pulse current generation device, and the pulse current generation device calculates a PWM signal that needs to be modulated by the current signal I.

For example, the target current signal is input to the pulse current generation device, and the pulse current generation device calculates the required PWM signal using a P algorithm, a PI algorithm, or a PID algorithm. In some embodiments, a modulation frequency of the pulse width modulation (PWM) signal is greater than a preset threshold, which is an upper limit of a sound frequency perceivable by a human ear. In this way, the pulse current is adjusted using a high-frequency PWM signal, which is above the range of human hearing, and the high-frequency modulation produces smaller current ripples. This can reduce the noise generated by the pulse current within a sound frequency range perceivable by a human ear, making the resonance sound closer to the frequency curve of the music or melody.

For example, if the sound frequency range perceivable by the human ear is 20 Hz to 20 kHz, the modulation frequency of the PWM signal may be set to 20 kHz or more. Thus, the current noise at this modulation frequency is inaudible to the human ear.

In some embodiments, the pulse width modulation (PWM) signal is a pulse width modulation (PWM) signal or a pulse width modulation (PWM) signal sequence at a specific moment.

In this way, since the modulation frequency of the PWM signal is set to be 20 kHz or more, it occupies only a very short time (moment) in the time domain. Thus, the pulse current can be adjusted using a PWM signal with a short occupation time, achieving a fast response and thus quickly converting the resonance sound into music or melody.

After the pulse width modulation (PWM) signal for adjusting a current is generated, in step 104, the pulse current is adjusted using the pulse width modulation (PWM) signal, and the adjusted pulse current is output.

In some embodiments, the pulse width modulation (PWM) signal may also be calculated in combination with other noises in the vehicle. For example, the pulse width modulation (PWM) signal is calculated according to the target current signal and frequency characteristics of other noises in the vehicle.

For example, other noises in the vehicle are collected by a sensor, and the frequency characteristics of these other noises are analyzed, so as to calculate the pulse width modulation (PWM) signal for adjusting a current in combination with the target current signal.

For example, other noises in the vehicle include wind noise, tire noise, and transmission system noise.

In this way, the PWM signal can be further generated in combination with other noises in the vehicle. Thus, the music or melody converted from the resonance sound can also cover other noises in the vehicle, thereby further improving the user experience and comfort.

FIG. 3 is a block diagram of a method for adjusting a pulse current using a pulse width modulation (PWM) signal according to the embodiment of the present invention. As illustrated in FIG. 3, the method includes:
a step 301 of inputting the pulse width modulation (PWM) signal into a switching element; and
a step 302 of adjusting an amplitude of a pulse current output by the switching element using the pulse width modulation (PWM) signal, thereby obtaining the adjusted pulse current.

In this way, the amplitude of the pulse current is adjusted in the time domain only based on the PWM signal, without the need to control or change the switching frequency of the switching element. This achieves a fast response without affecting the pulse current, that is, the heating effect on the power battery is ensured while the noise conversion effect is achieved.

In some embodiments, the switching element may be various types of switching elements, such as an insulated gate bipolar transistor (IGBT).

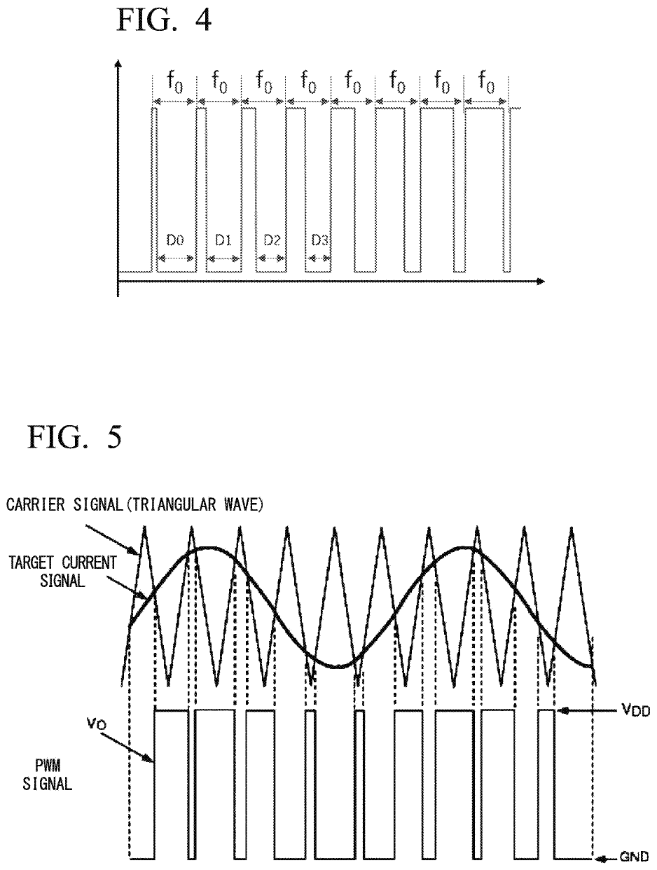

FIG. 4 is a waveform diagram of a pulse width modulation (PWM) signal applied to an IGBT according to the embodiment of the present invention. As illustrated in FIG. 4, a high-frequency PWM signal is used to control the IGBT to have different duty cycles D0, D1, D2, D3, but a switching frequency f0 of the IGBT is fixed.

FIG. 5 is a waveform diagram illustrating the generation of a pulse width modulation (PWM) signal using a target current signal according to the embodiment of the present invention. As illustrated in FIG. 5, the target current signal is compared with a high-frequency carrier signal (triangular wave), and an amplitude of the target current signal can be converted into a duty cycle value of the PWM signal. Specifically, the comparison is performed as follows. If the carrier signal is greater than the target current signal, a positive duty cycle signal (1) is output, and if the carrier signal is less than the target current signal, a negative duty cycle signal (0) is output. In other words, a continuous target current signal is discretized into a duty cycle signal, that is, a PWM signal.

The PWM signal drives a switching element (for example, IGBT) and a pulse generation device to obtain an output voltage or current of a target amplitude. The output current or voltage signal is a smooth sine wave, which can produce audibly pleasing music or melody.

In step 105, the power battery is heated using the adjusted pulse current. The specific heating process may refer to the related art of pulse current heating, which will not be specifically described herein.

The application scenarios and embodiments of the pulse heating method for the power battery according to the embodiments of the present invention will be exemplarily described below through specific examples.

### Examples of Application Scenarios

Application scenario 1: low-temperature charging: In cold or low-temperature environments, the charging efficiency of power batteries decreases significantly, leading to a longer charging time and potentially affecting battery life. The power batteries can be heated before or during charging through pulse heating, allowing it to quickly reach the optimal temperature for charging, thereby improving the charging efficiency and shortening the charging time.

Application scenario 2: vehicle starting and driving: low temperatures can reduce battery output power, resulting leading to difficulties in starting vehicles and decreased performance. In cold or low-temperature environments, pulse heating can quickly preheat power batteries before vehicle startup, improving battery performance and allowing vehicles to start and operate smoothly. During vehicle operation, pulse heating can also continuously maintain the battery temperature, ensuring stable power output and improving vehicle power performance.

Application scenario 3: parking and temperature maintenance: When a vehicle is parked in a low-temperature environment for an extended period, the battery temperature will gradually decrease. Pulse heating can be activated while a vehicle is parked to maintain the temperature of the power battery within a suitable range, preventing damage to the power battery due to prolonged low temperatures and preparing it for subsequent vehicle startup and use.

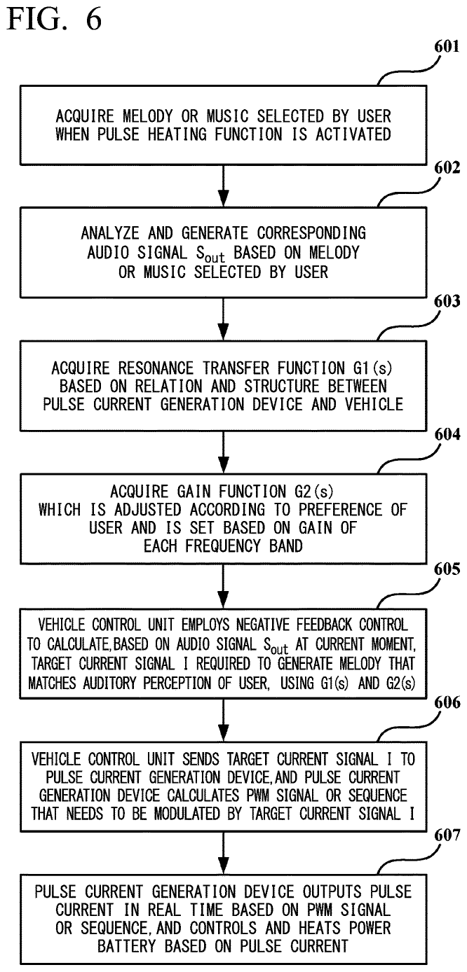

FIG. 6 is a flowchart of an embodiment of a pulse heating method for a power battery based on an embodiment of the present invention. As illustrated in FIG. 6, the method includes:
a step 601 of acquiring melody or music selected by a user when a pulse heating function is activated;
a step 602 of analyzing and generating a corresponding audio signal Sₒᵤₜ based on the melody or music selected by the user, the audio signal Sₒᵤₜ being a pitch at a specific time;
a step 603 of acquiring a resonance transfer function G1(s) according to a relation and structure between a pulse current generation device and a vehicle;
a step 604 of acquiring a gain function G2(s) which is adjusted according to a preference of the user and set based on the gain of each frequency band;
a step 605 of the vehicle control unit employing negative feedback control to calculate, based on the audio signal Sₒᵤₜ at the current moment, a target current signal I required to generate melody that matches the auditory perception of the user, using G1(s) and G2(s);
a step 606 of the vehicle control unit sending the target current signal I to the pulse current generation device, and the pulse current generation device calculating a PWM signal or sequence that needs to be modulated by the target current signal I; and
a step 607 of the pulse current generation device outputting a pulse current in real time based on the PWM signal or sequence, and controlling and heating the power battery according to the pulse current.

According to the above embodiment, the target current signal is generated based on the target audio parameter, the PWM signal is generated based on the target current signal, the pulse current is directly adjusted using the PWM signal in the time domain, and the power battery is heated using the adjusted pulse current. Thus, through a simple control process, a resonance sound caused by the pulse current can be quickly and effectively converted into pleasant music or melody, thereby improving the user experience and comfort.

Since the pulse current is adjusted using PWM only in the time domain and not controlled or adjusted in the frequency domain, it does not affect the pulse current, and therefore does not affect the heating effect on the power battery.

In addition, the resonance sound caused by the pulse current in this manner can be converted into music or melody with a sine wave or similar waveform, which has a good auditory effect, can make the user feel pleasant, and improve the user experience.

### Embodiment of Second Aspect

An embodiment of the second aspect of the present invention provides a pulse current generation device. The pulse current generation device corresponds to some steps of the pulse heating method for a power battery according to the embodiment of the first aspect of the present invention, for example, steps 103 and 104 in FIG. 1. For functions of the pulse current generation device, refer to related description in the embodiment of the first aspect, and repeated content will not be specifically described.

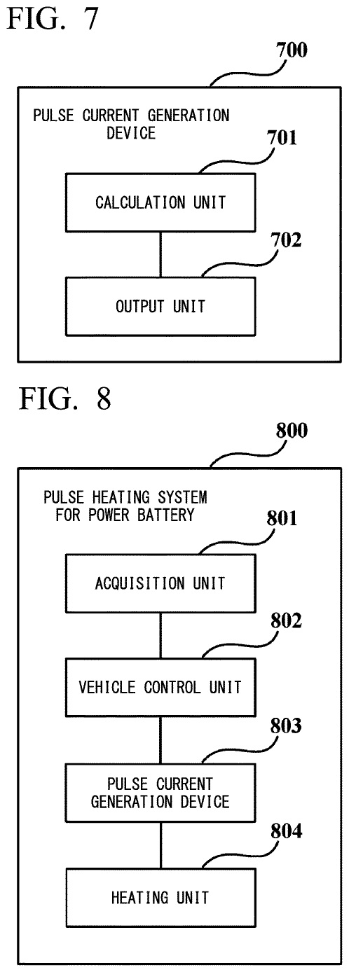

FIG. 7 is a block diagram of the pulse current generation device according to the embodiment of the present invention. As illustrated in FIG. 7, a pulse current generation device 700 includes:
a calculation unit 701 configured to calculate a pulse width modulation (PWM) signal at least according to a target current signal; and
an output unit 702 configured to adjust a pulse current using the pulse width modulation (PWM) signal, and output the adjusted pulse current, the target current signal being generated according to the target audio parameter.

In some embodiments, the calculation unit 701 calculates the pulse width modulation (PWM) signal according to the target current signal and frequency characteristics of other noises in the vehicle.

For specific functions of the calculation unit 701 and the output unit 702, refer to specific content of the related steps in the embodiment of the first aspect, and details will not be described herein again.

According to the above embodiment, the target current signal is generated based on the target audio parameter, the PWM signal is generated based on the target current signal, the pulse current is directly adjusted using the PWM signal in the time domain, and the power battery is heated using the adjusted pulse current. Thus, through a simple control process, a resonance sound caused by the pulse current can be quickly and effectively converted into pleasant music or melody, thereby improving the user experience and comfort.

Since the pulse current is adjusted using PWM only in the time domain and not controlled or adjusted in the frequency domain, it does not affect the pulse current, and therefore does not affect the heating effect on the power battery.

In addition, the resonance sound caused by the pulse current in this manner can be converted into music or melody with a sine wave or similar waveform, which has a good auditory effect, can make the user feel pleasant, and improve the user experience.

### Embodiment of Third Aspect

An embodiment of the third aspect of the present invention provides a pulse heating system for a power battery. The pulse heating system for a power battery corresponds to the pulse heating method for a power battery according to the embodiment of the first aspect of the present invention. In addition, the pulse heating system for a power battery may include the pulse current generation device according to the embodiment of the second aspect, and repeated content will not be specifically described.

FIG. 8 is a block diagram of the pulse heating system of a power battery according to the embodiment of the present invention. As illustrated in FIG. 8, a pulse heating system 800 of a power battery includes:
an acquisition unit 801 configured to acquire a target audio parameter;
a vehicle control unit 802 configured to generate a target current signal according to the target audio parameter;
a pulse current generation device 803 configured to receive at least the target current signal and output a pulse current adjusted with a pulse width modulation (PWM) signal; and
a heating unit 804 configured to heat the power battery using the adjusted pulse current.

In some embodiments, the acquisition unit 801 may be installed in a vehicle, for example, installed in an in-vehicle infotainment, or may be installed on a cloud server.

In some embodiments, the vehicle control unit 802, the pulse current generation device 803, and the heating unit 804 are installed in a vehicle.

For specific functions of the acquisition unit 801, the vehicle control unit 802, the pulse current generation device 803, and the heating unit 804, refer to specific content of the related steps in the embodiment of the first aspect, and details will not be described herein again.

According to the above embodiment, the target current signal is generated based on the target audio parameter, the PWM signal is generated based on the target current signal, the pulse current is directly adjusted using the PWM signal in the time domain, and the power battery is heated using the adjusted pulse current. Thus, through a simple control process, a resonance sound caused by the pulse current can be quickly and effectively converted into pleasant music or melody, thereby improving the user experience and comfort.

Since the pulse current is adjusted using PWM only in the time domain and not controlled or adjusted in the frequency domain, it does not affect the pulse current, and therefore does not affect the heating effect on the power battery.

In addition, the resonance sound caused by the pulse current in this manner can be converted into music or melody with a sine wave or similar waveform, which has a good auditory effect, can make the user feel pleasant, and improve the user experience.

### Embodiment of Fourth Aspect

An embodiment of the present invention provides a vehicle, including the pulse current generation device according to the embodiment of the second aspect or the pulse heating system of a power battery according to the embodiment of the third aspect.

In some embodiments, the vehicle may be a vehicle of various applications, such as a small passenger car, a truck, etc.

In some embodiments, the vehicle may be various vehicles that use power batteries, such as new energy vehicles, hybrid electric vehicles, etc.

When the pulse heating method of a power battery according to the embodiment of the first aspect, the pulse current generation device according to the embodiment of the second aspect, or the pulse heating system of a power battery according to the embodiment of the third aspect of the present invention is applied to a vehicle, through a simple control process, a resonance sound caused by the pulse current can be quickly and effectively converted into pleasant music or melody, thereby improving the user experience and comfort.

An embodiment of the present invention further provides a computer-readable program, which, when executed, causes a computer to execute the pulse heating method for a power battery according to the embodiment of the present invention.

An embodiment of the present invention further provides a computer-readable storage medium storing a computer program, which enables a computer to execute the pulse heating method for a power battery according to the embodiment of the present invention.

The above device and method in the embodiments of the present invention may be implemented by hardware, or may be implemented by a combination of hardware and software. The present invention relates to a computer-readable program which, when executed by a logic unit, enables the logic unit to implement the device or components described above, or to perform the various methods or steps described above.

The embodiments of the present invention further relate to a storage medium for storing the above program, such as a hard disk, a magnetic disk, an optical disk, a DVD, a flash memory, etc.

It should be noted that the limitations of the steps in the embodiments of the present invention are not considered to limit the sequence of the steps on the premise of not affecting the implementation of specific solutions. The steps described earlier may be executed first, or may be executed later, or even executed at the same time. As long as the solutions can be implemented, it should be regarded as falling within the protection scope of the present invention.

The present invention has been described above with reference to specific embodiments, but those skilled in the art should understand that these descriptions are exemplary and are not intended to limit the protection scope of the present invention. Those skilled in the art can make various variations and modifications to the present invention according to the scope and principle of the present invention, and these variations and modifications are also within the scope of the present invention.

What is claimed is:

1. A pulse heating method of a power battery, the pulse heating method comprising:
a step of acquiring a target audio parameter;
a step of generating a target current signal at least based on the target audio parameter;
a step of calculating a pulse width modulation (PWM) signal for adjusting a current, at least based on the target current signal;
a step of adjusting a pulse current using the pulse width modulation (PWM) signal, and outputting the adjusted pulse current; and
a step of heating the power battery using the adjusted pulse current.

2. The pulse heating method of a power battery according to claim 1, wherein
the step of acquiring the target audio parameter includes
a step of acquiring predetermined or user-selected melody or music, and
a step of generating, based on the melody or music, a corresponding time-domain audio signal as the target audio parameter or a part of the target audio parameter.

3. The pulse heating method of a power battery according to claim 2, further comprising:
a step of updating the melody or music based on an operation command of a user; and
a step of generating a corresponding time-domain audio signal based on the updated melody or music, and updating the target audio parameter or a part of the target audio parameter.

4. The pulse heating method of a power battery according to claim 1, wherein
the target current signal is a sine wave signal or an approximate sine wave signal.

5. The pulse heating method of a power battery according to claim 1, wherein
the step of generating a target current signal at least based on the target audio parameter includes
a step of generating the target current signal based on the target audio parameter, a sound resonance transfer function, and an audio gain function,
the sound resonance transfer function is determined according to a relation and structure between a pulse current generation device configured to output the pulse current, and a vehicle, and the audio gain function is adjusted based on a user preference and is set based on a gain of each frequency band.

6. The pulse heating method of a power battery according to claim 5, wherein
the target audio parameter includes a time-domain audio signal, and
the target current signal is equal to a product of the time-domain audio signal, the sound resonance transfer function, and the audio gain function.

7. The pulse heating method of a power battery according to claim 1, wherein
a modulation frequency of the pulse width modulation (PWM) signal is greater than a preset threshold, which is an upper limit of a sound frequency perceivable by a human ear.

8. The pulse heating method of a power battery according to claim 1, wherein
the pulse width modulation (PWM) signal is a pulse width modulation (PWM) signal or a pulse width modulation (PWM) signal sequence at a specific time.

9. The pulse heating method of a power battery according to claim 1, wherein
the step of adjusting the pulse current using the pulse width modulation (PWM) signal, and outputting the adjusted pulse current includes
a step of inputting the pulse width modulation (PWM) signal into a switching element, and
a step of adjusting an amplitude of a pulse current output by the switching element using the pulse width modulation (PWM) signal, thereby obtaining the adjusted pulse current.

10. The pulse heating method of a power battery according to claim 1, wherein
the step of calculating the pulse width modulation (PWM) signal for adjusting a current, at least based on the target current signal includes
a step of calculating the pulse width modulation (PWM) signal based on the target current signal and frequency characteristics of other noises in a vehicle.

11. A pulse current generation device, comprising:
a calculation unit configured to calculate a pulse width modulation (PWM) signal at least based on a target current signal; and
an output unit configured to adjust a pulse current using the pulse width modulation (PWM) signal, and output the adjusted pulse current, and
wherein the target current signal is generated based on a target audio parameter.

12. The pulse current generation device according to claim 11, wherein
the calculation unit calculates the pulse width modulation (PWM) signal based on the target current signal and frequency characteristics of other noises in a vehicle.

13. A pulse heating system of a power battery, the pulse heating system comprising:
an acquisition unit configured to acquire a target audio parameter;
a vehicle control unit configured to generate a target current signal based on the target audio parameter;
a pulse current generation device configured to receive at least the target current signal and output a pulse current adjusted with a pulse width modulation (PWM) signal; and
a heating unit configured to heat the power battery using the adjusted pulse current.

14. A vehicle, comprising:
the pulse current generation device according to claim 11.

15. A vehicle comprising:
the pulse heating system of a power battery according to claim 13.
